(19) United States
(12) Patent Application Publication
(10) Pub. No.: US 2008/0288902 A1
(43) Pub. Date: Nov. 20, 2008

(54) CIRCUIT DESIGN VERIFICATION METHOD AND APPARATUS AND COMPUTER READABLE MEDIUM

(75) Inventors: Takeo Nishide, Kawasaki-shi (JP); Takehiko Tsuchiya, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 12/117,018

(22) Filed: May 8, 2008

(30) Foreign Application Priority Data
May 14, 2007 (JP) 2007-128395

(51) Int. Cl. G06F 17/50

(52) U.S. Cl. 716/5

(57) ABSTRACT

There is provided with a circuit design verification method including: accepting input of a circuit description which describes a circuit by using a plurality of conditional statements each including one or more conditional elements; extracting each conditional statement included in the circuit description and each conditional element included in the conditional statements; executing the circuit description by using test data for the circuit; and generating a table including verification information for each conditional statement, the verification information representing (A1) whether each conditional element has been always true, (A2) whether each conditional element has been always false, or (A3) whether each conditional element has been both true and false when the conditional statement is satisfied.

### CROSS REFERENCE TO RELATED APPLICATIONS

This application is based upon and claims the benefit of priority from the prior Japanese Patent Applications No. 2007-128395, filed on May 14, 2007; the entire contents of which are incorporated herein by reference.

### BACKGROUND OF THE INVENTION

1. Field of the Invention

The present invention relates to a method for circuit design verification suitably used to reuse, for example, a logic circuit in designing and verifying a new circuit, and an apparatus for performing the method and a computer readable medium.

2. Related Art

In recent years, with the increase in circuit scale and the reduced TAT (turn around time) in the design of system LSIs (large-scale integration), circuit modules, such as IP (intellectual property: reusable design assets) and past design assets, are reused in order to reduce design and verification costs and to improve the quality.

No bug occurs when a reused module is consistent with a function required for a module (for example, a module on a preceding stage) in communication with the reused module. However, in the case where a change is made to a function, such as the addition of a new function to the module on the preceding stage, a bug occurs when the added function is performed, because the reused module does not have the function corresponding to the added function.

### SAMMARY OF THE INVENTION

According to an aspect of the present invention, there is provided with a circuit design verification method comprising:

accepting input of a circuit description which describes a circuit by using a plurality of conditional statements each including one or more conditional elements;

extracting each conditional statement included in the circuit description and each conditional element included in the conditional statements;

executing the circuit description by using test data for the circuit; and

generating a table including verification information for each conditional statement, the verification information representing (A1) whether each conditional element has been always true, (A2) whether each conditional element has been always false, or (A3) whether each conditional element has been both true and false when the conditional statement is satisfied.

According to an aspect of the present invention, there is provided with a circuit design verification apparatus comprising:

an input accepting unit configured to accept input of a circuit description which describes a circuit by using a plurality of conditional statements each including one or more conditional elements;

an extracting unit configured to extract each conditional statement included in the circuit description and each conditional element included in the conditional statements;

an executing unit configured to execute the circuit description by using test data for the circuit and;

a table generating unit configured to generate a table including verification information for each conditional statement, the verification information representing (A1) whether each conditional element has been always true, (A2) whether each conditional element has been always false, or (A3) whether each conditional element has been both true and false when the conditional statement is satisfied.

According to an aspect of the present invention, there is provided with a computer readable medium storing a computer program for causing a computer to execute instructions to perform the steps of:

accepting input of a circuit description which describes a circuit by using a plurality of conditional statements each including one or more conditional elements;

extracting each conditional statement included in the circuit description and each conditional element included in the conditional statements;

executing the circuit description by using test data for the circuit; and

generating a table including verification information for each conditional statement, the verification information representing (A1) whether each conditional element has been always true, (A2) whether each conditional element has been always false, or (A3) whether each conditional element has been both true and false when the conditional statement is satisfied.

### BRIEF DESCRIPTION OF THE DRAWINGS

FIG. 1 is a block diagram of a system circuit under new development;

FIG. 2 is a figure for explaining a problem instance which is caused in the system circuit under new development;

FIG. 3 is a state transition diagram for explaining the above described problem instance;

FIG. 4 is a figure of a circuit description for explaining the above described problem instance;

FIG. 5 shows a configuration of a system as Embodiment 1 according to the present invention;

FIG. 6 shows an example of a circuit description (a part of slave state transition description) of a device under test;

FIG. 7 is a figure for explaining processing of a table creation/display unit in the system shown in FIG. 5;

FIG. 8 shows an example of a table generated by the table creation/display unit;

FIG. 9 shows an example of a table generated by a coverage value calculation/display unit in the system shown in FIG. 5;

FIG. 10 shows a configuration of a system as Embodiment 2 according to the present invention;

FIG. 11 shows an example of an inserting method of a monitor code;

FIG. 12 shows an example of a coverage value calculation method;

FIG. 13 shows an example of a table generated by Embodiment 2;

FIG. 14 shows a configuration of a system as Embodiment 3-1 according to the present invention;

FIG. 15 shows a generated example of a check proposition description;

FIG. 16 shows an example of a coverage value calculation method;

FIG. 17 shows a configuration of a system as Embodiment 3-2 according to the present invention;

FIG. 18 shows a generated example of a check proposition description;

FIG. 19 shows an example of a coverage calculation method;

FIG. 20 shows a configuration of a system as Embodiment 4 according to the present invention;

FIG. 21 shows a configuration of a system as Embodiment 5 according to the present invention;

FIG. 22 shows a table generated from a system circuit under new development; and

FIG. 23 shows an example of a function change part between the designed system circuit and the system circuit under new development.

### DETAILED DESCRIPTION OF THE INVENTION

In the following, firstly, an example of the bug occurred when the reused module is used will be exemplified.

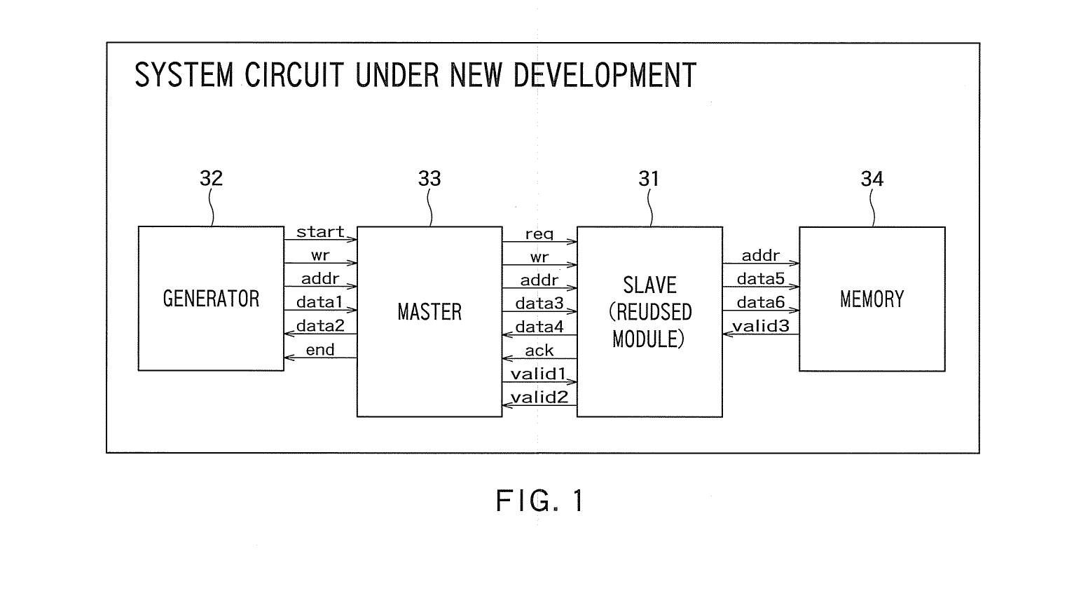

In a system circuit under new development shown in FIG. 1, it is assumed that a slave 31 is a reused module, the other modules, that is, a generator 32, a master 33, and a memory 34 are modules under new development.

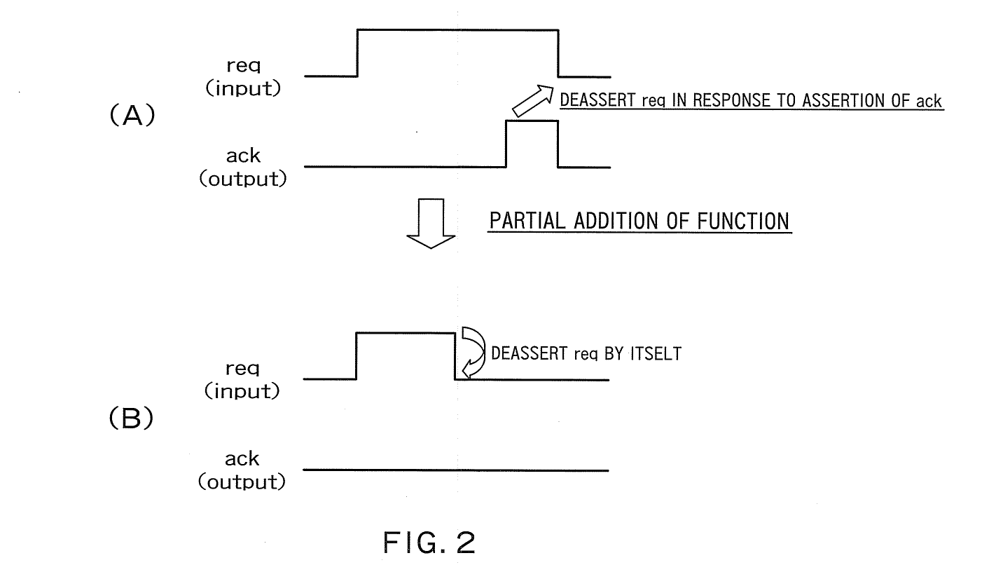

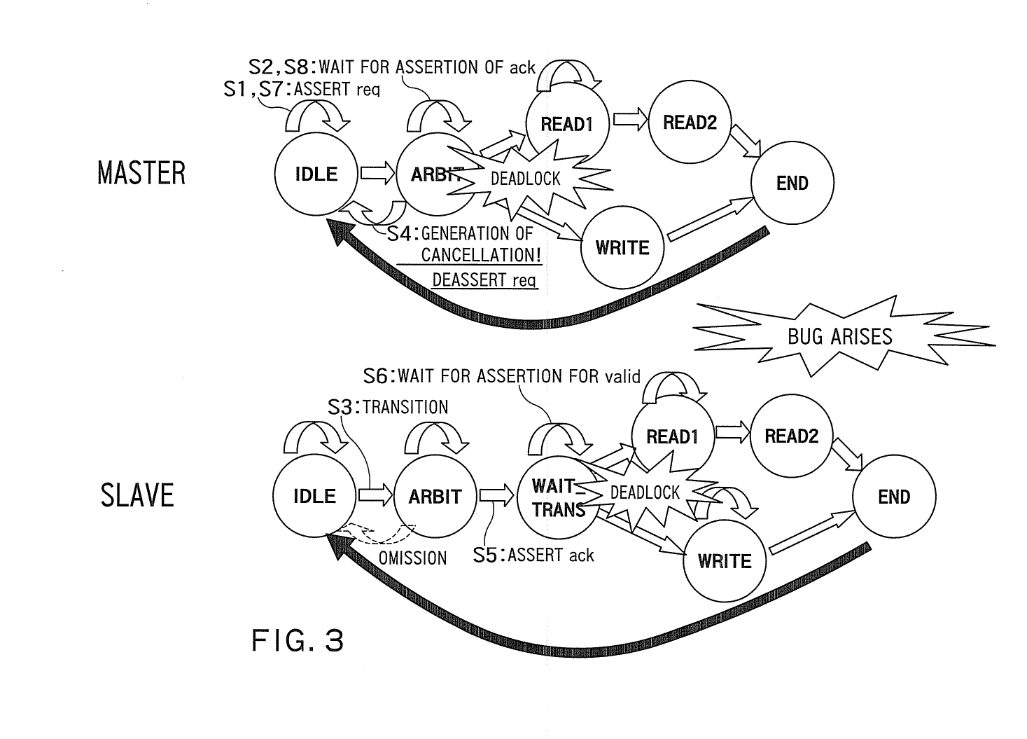

Regarding a handshake such as requesting and acknowledging operations in a transaction, consider that a request cancel function, which is not supported in the prior system circuit, is supported in the system circuit under new development. That is, as shown in FIG. 2A, in the prior system circuit, a req signal (representing the request) from the master is not deasserted until an ack signal (representing the acknowledgement) is asserted by the slave after the req signal is issued by the master. However, consider that the system circuit under new development supports a request cancel function which enables the master itself to cancel the req signal, as shown in FIG. 2B. The master is provided with the cancel function, but the reused slave is not provided with a function corresponding to the cancel function, which causes a bug. A scenario leading to a bug will be described with reference to FIG. 3.

1. The master and the slave are in an initial IDLE state.

2. The master transitions to an ARBIT state after asserting a req signal (S1), and waits that an ack signal is asserted by the slave (S2).

3. The slave receives the assertion of the req signal and transitions to an ARBIT state (S3).

4. The master transitions to the IDLE state after deasserting the req signal (S4), (causing a request cancel).

5. The slave transitions to a WAIT_TRANS state after asserting the ack signal (S5), and waits that a valid signal indicating data transfer is asserted (S6).

6. The master transitions to the ARBIT state after again asserting the req signal (S7), and waits that the ack signal is asserted by the slave (S8).

7. A deadlock state is caused because both the master and the slave continue to wait that a signal is asserted by the other of them, (causing a bug).

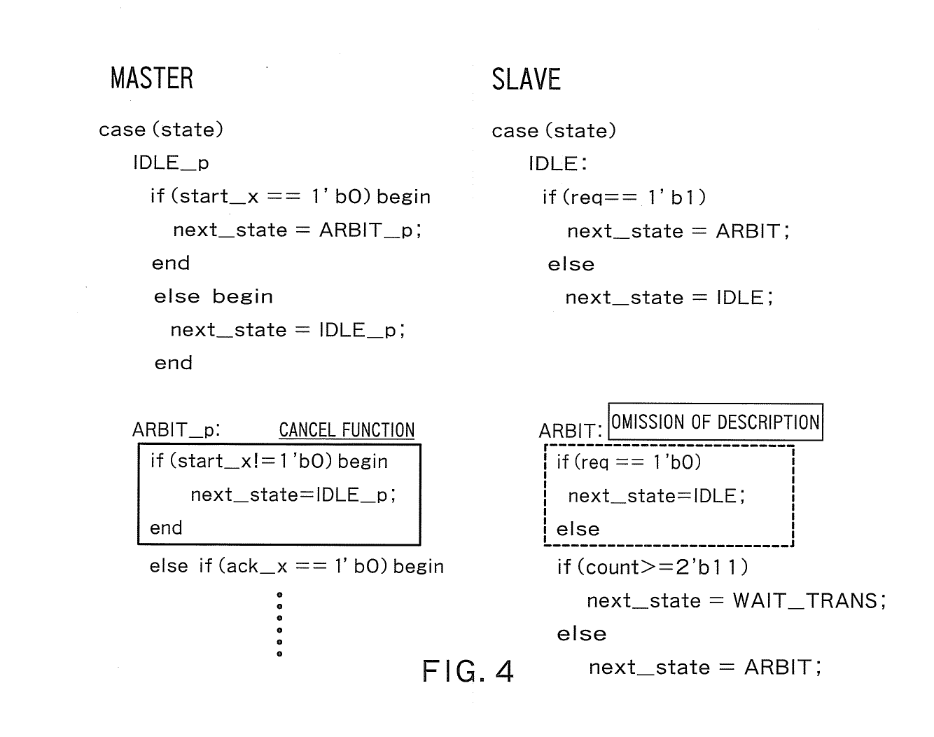

In the slave circuit description of the system circuit under new development, the description surrounded by the broken line shown in FIG. 4 will be required to address the cancel function newly implemented in the master. However, when the description is missing, the above described bug arises. Note that FIG. 4 shows a part of state transition description of the master and the slave, which describes the state transitions of the master and the slave. In the prior art, there is a problem that it is difficult to detect the description omission as described above, resulting in incomplete verification.

There are the following coverage measuring methods as a technique for avoiding the incomplete verification and for improving the verification accuracy.

Code Coverage

The code coverage is a defined coverage indicator which measures the presence or absence of execution of the code itself, such as “whether the statement has been executed?”, for each code described as a circuit. This is effective for measuring the presence or absence of execution of a function described as a code. However, there is a problem that an undescribed function is not included in the measuring object and hence the above described description omission cannot be detected.

Functional Coverage

Functional coverage is a coverage indicator which is defined by a user, and which measures the presence or absence of actual execution of a function, such as “whether the write transaction of each burst length has been generated?”. This is effective to measure the function itself, when there is no omission in the coverage definition by the user. However, there is a problem that when there is an omission in the coverage definition by the user, the above described description omission cannot be automatically detected.

Note that there is JP-A 2004-355130 (Kokai) as a document describing a technique for optimizing a circuit description. In the technique, the optimization is effected by automatically deleting an unexecuted part. In particular, the technique is configured to individually perform the measurement and the deletion by developing in line a function of verilog, each time the function is called. However, since the technique relies on the coverage result to delete the code, there is a possibility that an executable code is deleted in the case where the vector is not sufficient. The technique described in the patent document is to optimize the circuit description, and is unable to detect the description omission of an originally required function in the circuit description.

In the following, embodiments of the present invention will be explained that make it possible to detect the omission of the description of the originally required function in the circuit description.

### Embodiment 1

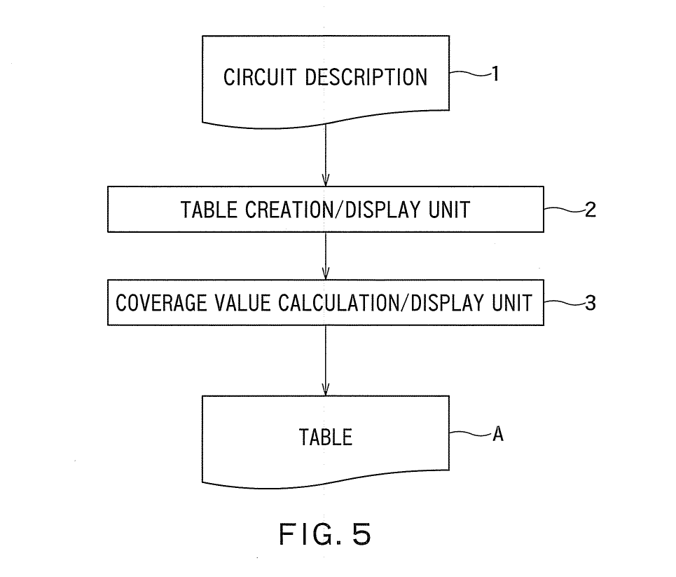

FIG. 5 shows a configuration of a system which executes a circuit design verification method as Embodiment 1 according to the present invention. It is also possible to realize a function equivalent to the system by making a computer (e.g. processor) execute a program in which instruction codes for executing the circuit design verification method are described. The program may be stored in a computer readable medium like a CD-ROM and hard-disk.

A circuit description 1 of a device under test (DUT) is inputted into the system.

A table creation/display unit 2 detects each conditional statement from the circuit description 1, and detects a conditional element (conditional description written in a logical expression, and the like) included in each conditional statement, so as to create and display, for each conditional statement, a table A representing a truth or false status of the conditional element which needs to be satisfied to make the conditional statement satisfied.

A coverage value calculation/display unit 3 calculates a coverage value representing a ratio of the number of the conditional elements whose truth or false needs to be satisfied to make each conditional statement satisfied, with respect to the total number of the conditional elements, on the basis of the table created by the table creation/display unit 2, and writes the calculated coverage value in the above described table A, so as to display and output the table A with the coverage value written therein.

In the following, a system shown in FIG. 5 will be explained by using a specific example.

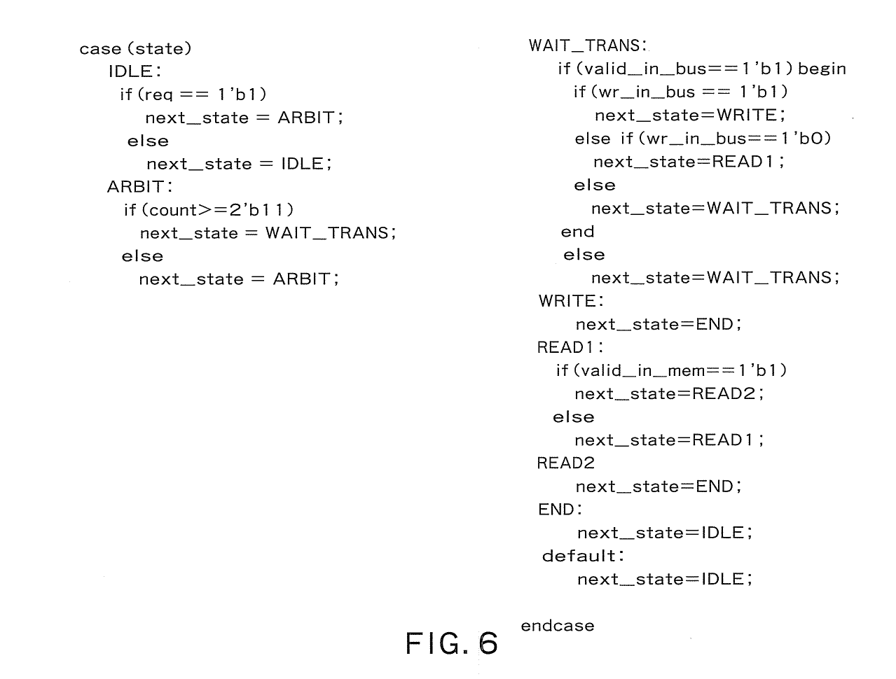

In the present example, it is assumed that a designer/verifier inputs a circuit description of a slave having a state transition machine. FIG. 6 shows a part of the description in which a state transition of the slave is determined according to whether or not a conditional statement is satisfied.

The designer/verifier inputs codes as shown in FIG. 6 into the system. The inputted codes are processed as follows by the table creation/display unit 2 and the coverage value calculation/display unit 3.

(1) The table creation/display unit 2 scans the circuit description 1 from its head, and extracts the present state (state), the transitioned state (next_state), and the conditional statement for the transition.

(2) The table creation/display unit 2 detects a conditional description (referred to as a subexpression, a conditional element, or the like) separated by a logical sum operator or a logical product operator, from a conditional statement (including a higher-level conditional statement in the case of a nesting structure) extracted in the step (1). One or more conditional elements are included in the detected one conditional statement.

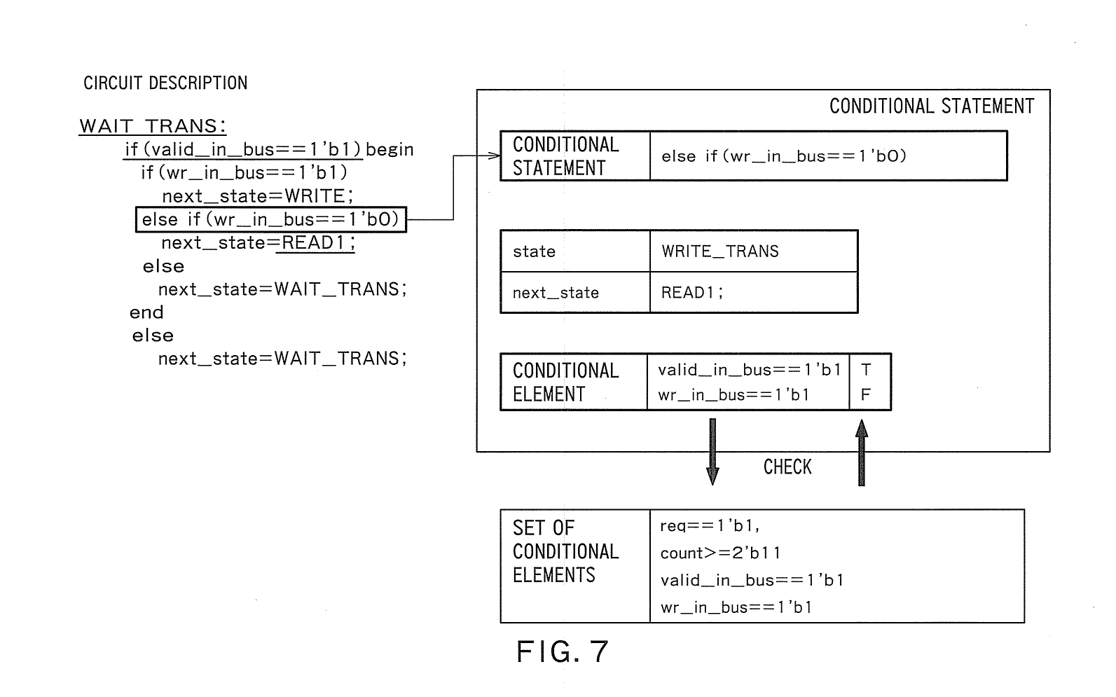

(3) The table creation/display unit 2 checks the conditional element detected in the step (2) against a set of conditional elements accumulated in the previous scans, and records, when there is the same conditional element, T (truth) for the conditional element. Also, the table creation/display unit 2 records, when there is the same conditional element with the exception that the logic is inverted, F (false) for the conditional element, and newly adds, when there is no same conditional element, the detected conditional element to the set of conditional elements, and records T for the added conditional element. However, in the present example, it is assumed that the same conditional element, or the same conditional element with the exception that the logic is inverted, is not included in two or more different “if-else” structures (except the case of nesting structure). In FIG. 7, there is shown an example in which the processing from (1) to (3) is performed with respect to a conditional statement “else if (wr_in_bus==1′b0)” in the circuit description 1. In the following description, “1′b0” means “0” of one bit, “1′b1” means “1” of one bit, and “2′b11” means “11” of two bits.

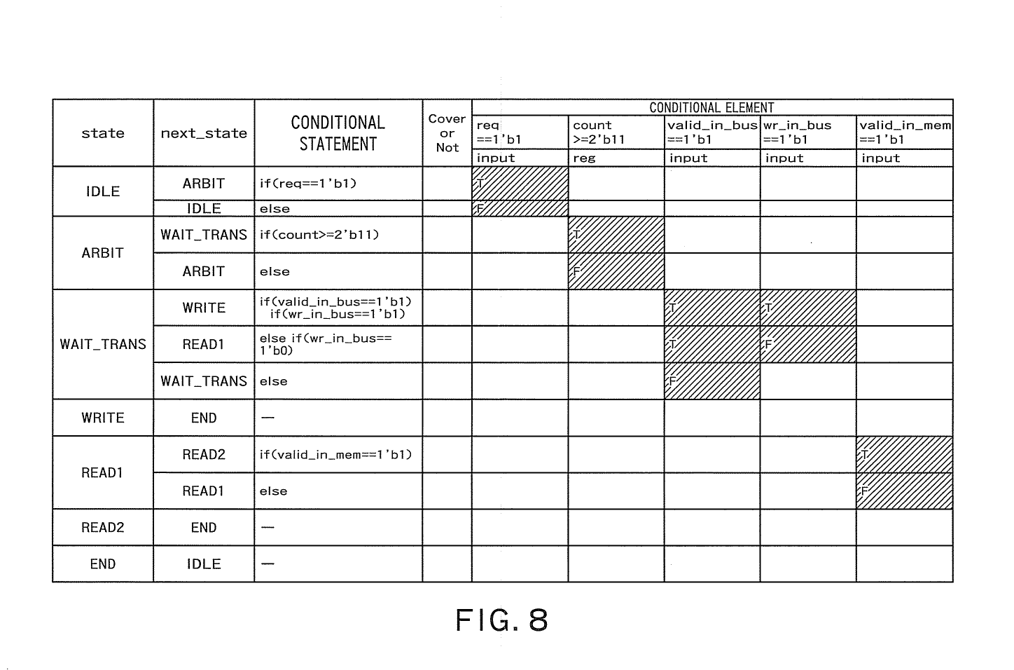

This conditional statement has a nesting structure. In order to establish the conditional statement, it is necessary that “valid_in_bus==1′b1” is true in the higher-level conditional statement “if (valid_in_bus==1′b1)”, in addition to that “wr_in_bus==1′b0” is true (that is, “wr_in_bus==1′b1” is false). Thus, in the processing in the step (2), both “wr_in_bus==1′b0” and “valid_in_bus==1′b1” are detected as the conditional elements. Then, in the processing in the step (3), “valid_in_bus==1′b1” is the same as “valid_in_bus==1′b1” included in the set of conditional elements, and hence T (true) is recorded for “valid_in_bus==1′b1” (F (false) may be recorded for “valid_in_bus==1′b0”). As for “wr_in_bus==1′b0”, the same conditional element is the same as “wr_in_bus==1′b1” recorded in the set of conditional elements with the exception that the logic is inverted, and hence F (false) is recorded. The cells of the table A shown in FIG. 8 are filled on the basis of these results. Here, a row whose state is specified by “WAIT_TRANS” of state, and whose next_state is specified by “READ1”, is filled.

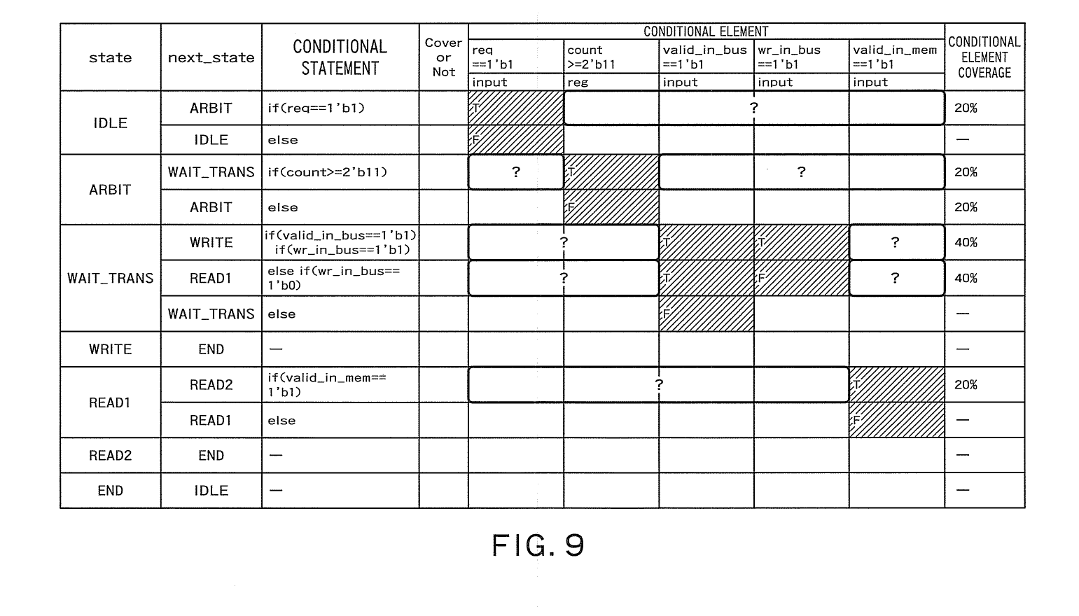

(4) The table A shown in FIG. 8 is obtained as a result of performing the processing from (1) to (3) for all the transitions. The cell having T (truth) means that the conditional element corresponding to the cell must be always true in order to establish the corresponding conditional statement. Similarly, the cell having F (false) means that the conditional element corresponding to the cell must be always false in order to establish the corresponding conditional statement. The “input” described in the table A indicates that the corresponding signal (for example, req, wr_in_bus) is an input signal to the device under test, and “reg” indicates that a corresponding signal (for example, count) is a value of a register used in the device under test. The table creation/display unit 2 may display the table A. Thereafter, for each of the transitions except a transition of else term (a term having no condition, for example, the conditional statement to transition from WAIT_TRANS to WAIT_TRANS in FIG. 8), the coverage value calculation/display unit 3 calculates an indicator (conditional element coverage) which is a ratio of the number of conditional elements whose truth or false needs to be satisfied to effect the transition (that is, the number of conditional elements whose truth or false needs to be satisfied to establish the conditional statement for effecting the transition) with respect to the total number of conditional elements, and describes the indicator in the above described table A. As a result, the table A becomes as shown in FIG. 9. The coverage value calculation/display unit 3 displays the table A. Note that the symbol “?” in the table A of FIG. 9 is to urge the designer/verifier to check (for example, that there is actually no problem without considering truth or false, or the like) in relation to the corresponding cell (a set of the conditional element and the transition (conditional statement)).

In the present embodiment, a table is created for the state transition description, but the present invention is of course applicable not only to the state transition description, but also to other circuit descriptions, such as a circuit operation description.

As described above, as compared with the conventional method which displays the state along the vertical axis, the next_state along the horizontal axis, and the conditional statement in each cell, according to the present embodiment, a conditional element whose truth or false needs to be satisfied to effect a target transition (that is, a conditional element whose truth or false needs to be satisfied to establish a conditional statement for effecting the transition, which hereinafter may be referred to as a necessary conditional element), and a conditional element whose truth or false need not be satisfied (which hereinafter may be referred to as a non-conditional element) are displayed by being separated from each other. This makes it possible to urge the designer/verifier to find the omission of condition, and thereby the improvement in the verification accuracy is expected.

Further, it is possible to present, as the conditional element coverage, “the detailedness of a conditional statement” (that is, how many of the number of the establishment of truth or false of conditional elements influence the establishment of the conditional statement), which closely relates to the omission of condition. Thereby, the improvement in verification accuracy is expected.

### Embodiment 2

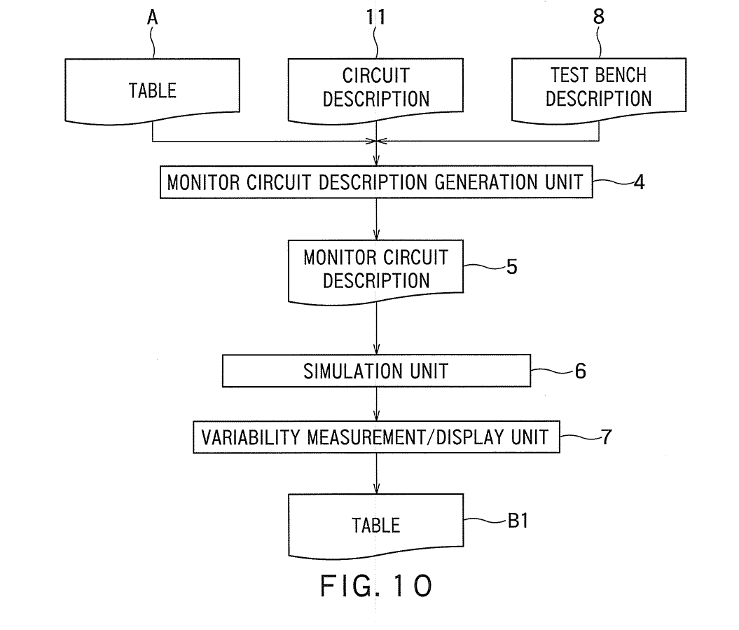

FIG. 10 shows a configuration of a system which performs a circuit design verification method, as Embodiment 2 according to the present invention. It is also possible to realize a function equivalent to the system by making a computer execute a program in which instruction codes for executing the circuit design verification method are described.

A circuit description (for example, a whole circuit description of a circuit system under new development) 11 including a circuit description of a device under test (DUT) and a circuit description of the other circuit which operates cooperatively with the device under test (DUT), are inputted into the system. The circuit description 11 includes, for example, a state transition description of each circuit in the system, and an operational description of each circuit. Further, a test bench description 8 of the device under test (DUT) and the table A obtained in Embodiment 1 are inputted into the system.

A monitor circuit description generation unit 4 inserts, into the circuit description 11, a monitor code for measuring truth or false of all non-conditional elements of a conditional statement corresponding to each transition of the table A, and generates a monitor circuit description 5.

A simulation unit (executing unit) 6 performs a simulation by using the monitor circuit description 5 and the test bench description 8. The test bench description corresponds, for example, to test data.

A variability measurement/display unit (table generating unit, display unit) 7 obtains a table B1 by adding a result (coverage result) obtained by the simulation to the table A. The variability measurement/display unit 7 displays the table B1.

In the following, a system shown in FIG. 10 will be explained by using a specific example.

The designer/verifier or the system of Embodiment 1 inputs, into the present system, the circuit description 11, the test bench description 8, and the table A which is generated in Embodiment 1 and shown in FIG. 8. The following processing is performed by the monitor circuit description generation unit 4, the simulation unit 6, and the variability measurement/display unit 7.

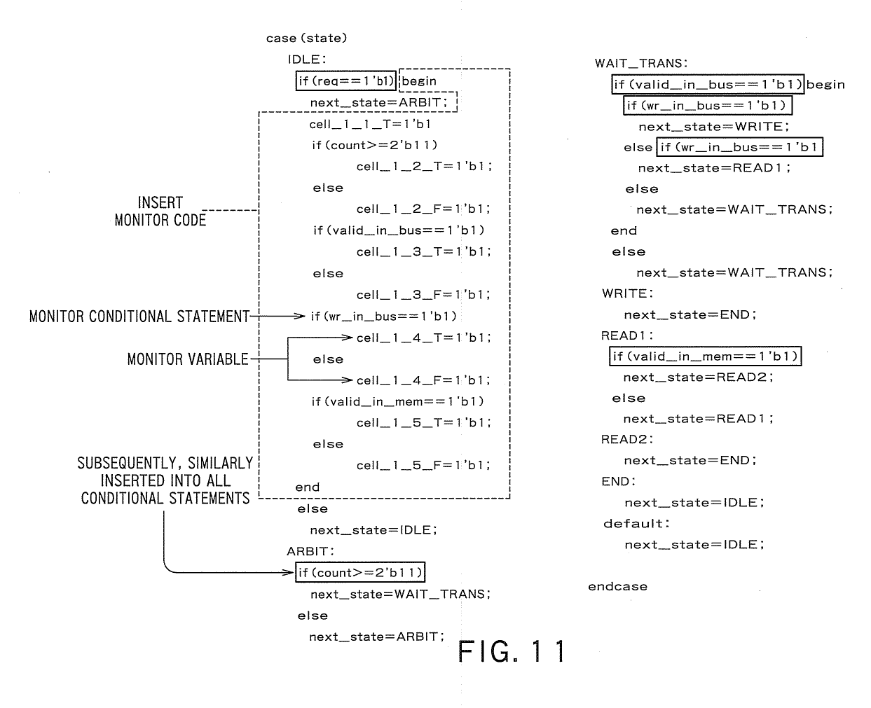

(1) The monitor circuit description generation unit 4 copies the circuit description 11, and generates a monitor circuit description 5 by inserting into the copy of the circuit description 11 a monitor code (a monitor conditional statement and a monitor variable) for measuring truth or false of all non-conditional elements of a condition statement corresponding to each transition of the table A. In this way, there is obtained the monitor circuit description 5 which enables truth or false of the non-conditional element to be measured when the conditional statement corresponding to each transition is satisfied. A state where the monitor circuit description 5 is generated is shown in FIG. 11.

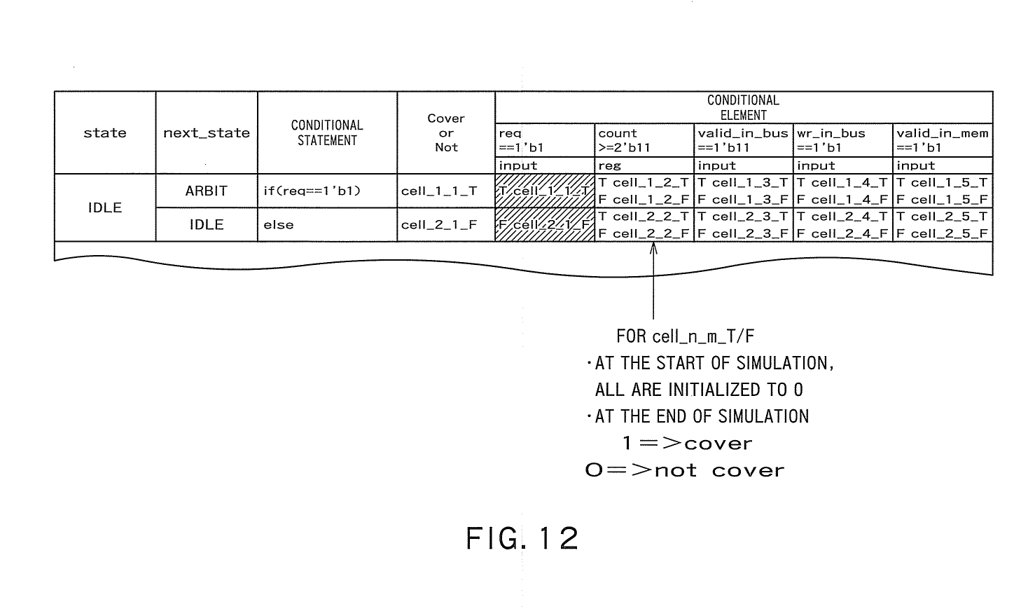

(2) The simulation unit 6 obtains a value of each monitor variable by performing a simulation by using the monitor circuit description 5 and the test bench description 8. That is, as shown in FIG. 12, two monitor variables (monitor variable cell_n_m_T, monitor variable cell_n_m_F) are obtained for each cell corresponding to the non-conditional element of the conditional statement.

The monitor variable cell_n_m_T and the monitor variable cell_n_m_F are respectively initialized to 0 at the start of the simulation. When the conditional statement for transition corresponding to the noted cell is satisfied, the value of the monitor variable cell_n_m_T is set to 1 in the case where the conditional element corresponding to the cell becomes true at least once during the simulation, while the value of the monitor variable cell_n_m_F is set to 1 in the case where the conditional element corresponding to the cell becomes false at least once.

Therefore, when cell_n_m_T is 1 and a cell_n_m_F is 0 after the simulation is ended, this means that when the conditional statement for transition corresponding to the noted cell is satisfied, the conditional element corresponding to the cell is always true (truth or false is invariable) (corresponding to verification information (A1)). Further, when cell_n_m_T is 0 and cell_n_m_F is 1 after the simulation is ended, this means that when the conditional statement for transition corresponding to the noted cell is satisfied, the conditional element corresponding to the cell is always false (truth or false is invariable) (corresponding verification information (A2)). Further, when cell_n_m_T is 1 and cell_n_m_F is 1 after the simulation is ended, this means that when the conditional statement for transition corresponding to the noted cell is satisfied, the conditional element corresponding to the cell is both true and false (truth or false is variable) (corresponding to verification information (A3)).

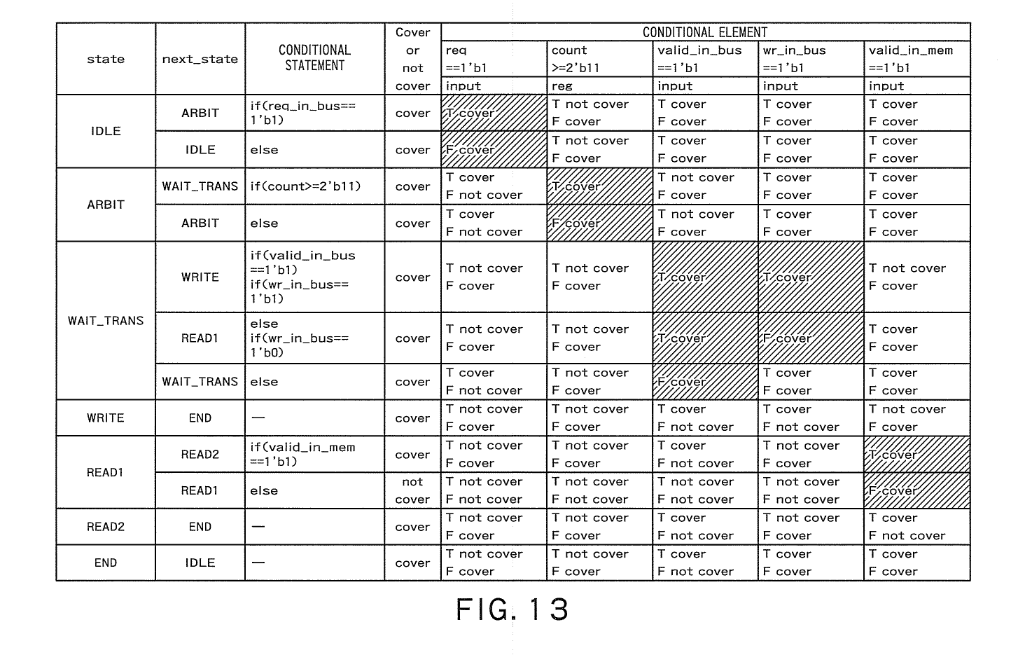

(3) The variability measurement/display unit 7 adds “cover” to the corresponding cell of table A when each monitor variable is 1, and adds “not cover” to the corresponding cell of table A when each monitor variable is 0. The monitor variable is measured to each cell, and thereby the table B1 as shown in FIG. 13 is obtained. The variable measurement/display unit 7 displays the table B1. For each of the cells, the cell in which “cover” is added to both T and F (i.e. cell of verification information (A3)), means that truth or false of the conditional element corresponding to the cell is “variable” while the conditional statement corresponding to the cell is satisfied (true). Also, the cell in which “cover” is added to one of T and F and “not cover” is added to the other (i.e. cell of verification information (A1) or (A2)), means that truth or false of the conditional element corresponding to the cell is “invariable” while the conditional statement corresponding to the cell is satisfied (true). In the hatched cell (a cell corresponding to a necessary conditional element of the conditional statement), since T or F needs to be always satisfied, “cover” is given to T or F which are originally written. Incidentally, a cell of only “T cover” corresponds to a cell of verification information (A1) and a cell of only “F cover” corresponds to a cell of verification information (A2). Note that the field of “cover or not cover” in the table B1 represents whether the conditional statement corresponding to each transition has been executed at least once during the simulation. In the field, “cover” means that the conditional statement has been executed at least once, while “not cover” means that the conditional statement has never been executed.

As described above, according to the present embodiment, there are displayed not only truth or false condition which needs to be satisfied by the necessary conditional element corresponding to the conditional statement of each transition, but also the variability of truth and false (“invariableness” or “variableness”) of the non-conditional element. Thereby, it is possible to urge the designer/verifier to check whether the non-conditional element, which is variable but is not included in the conditional statement, needs to be included in the conditional statement, and the like. This results in the finding of the omission of condition. Thereby, the improvement in the verification accuracy is expected.

### Embodiment 3-1

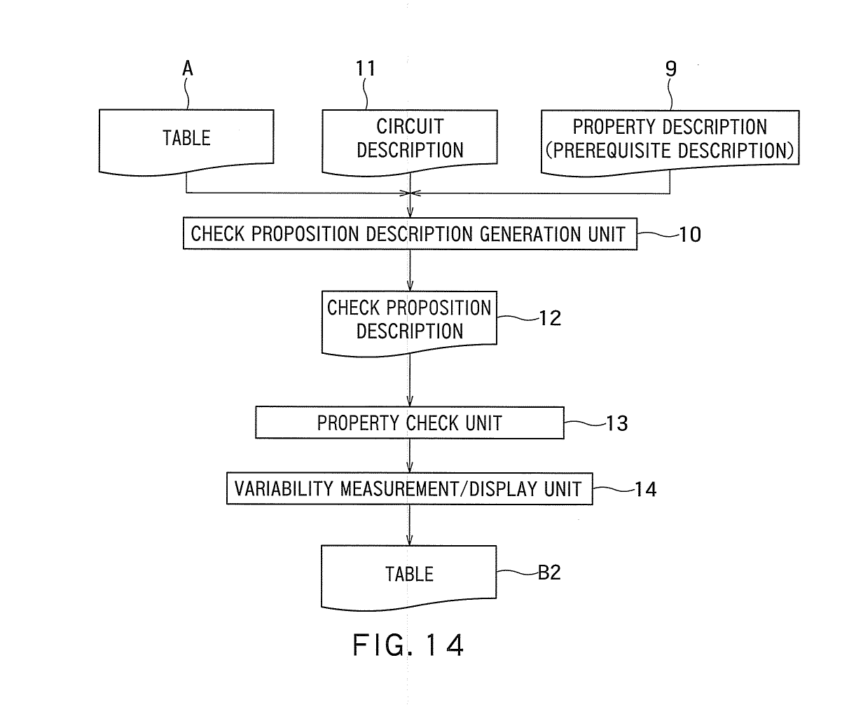

FIG. 14 shows a configuration of a system which performs a circuit design verification method, as Embodiment 3-1 according to the present invention. It is also possible to realize a function equivalent to the system by making a computer execute a program in which instruction codes for executing the circuit design verification method are described.

A circuit description 11 including a circuit description of a device under test (DUT) and a circuit description of the other circuit which operates cooperatively with the device under test are inputted into the system. Further, a property description (prerequisite description) 9 in which restrictions (for example, a restriction on a range of values that a signal can take, and a restriction on a relation between a signal value and the other signal value) relating to input signals and internal signals (req, count, valid_in_bus, and the like) of the device under test (DUT) are expressed by a property language, and the table A obtained in Embodiment 1 are inputted into the present system.

A check proposition description generation unit 10 generates a check proposition description 12 for measuring truth or false of all non-conditional elements of a conditional statement corresponding to each transition of the table A.

A property check unit (executing unit) 13 performs property check to the circuit description of the device under test (DUT) by using the check proposition description 12. In the present example, the property check is performed with respect to a state transition description corresponding to the table A generated in Embodiment 1 among the circuit descriptions of the device under test, but the application of the present invention is not limited to this.

A variability measurement/display unit (table generating unit, display unit) 14 obtains a table B2 by adding to the table A the result (coverage result) obtained by the property check. The variability measurement/display unit 14 displays the table B-2.

In the following, a system shown in FIG. 14 will be explained by using a specific example.

A designer/verifier or the system of Embodiment 1 inputs the circuit description 11, the property description (prerequisite description) 9, and the table A generated in Embodiment 1.

The following processing is performed by the check proposition description generation unit 10, the property check unit 13, and the variability measurement/display unit 14.

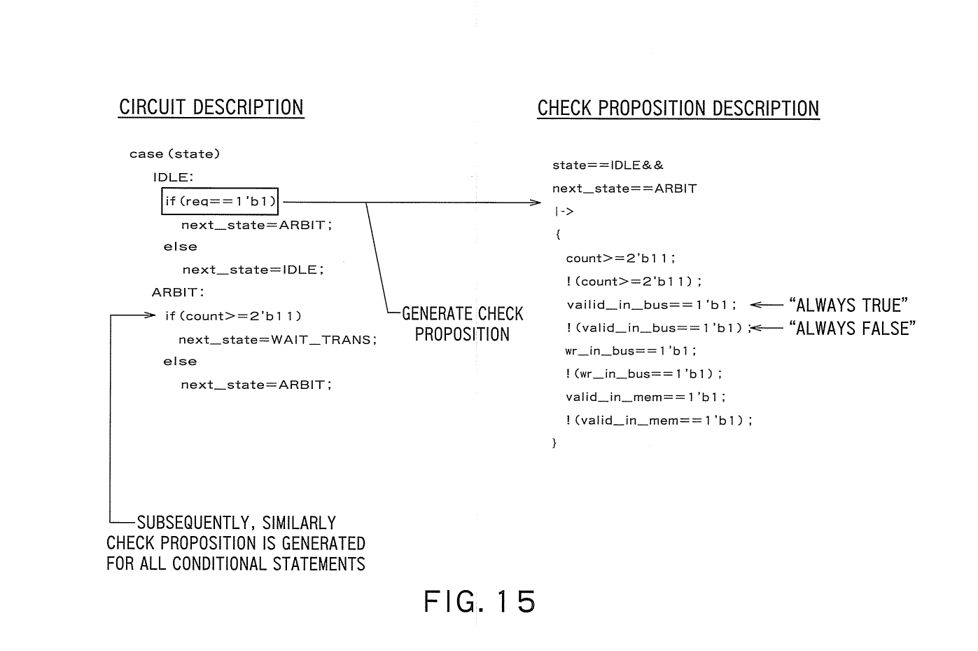

(1) The check proposition description generation unit 10 creates, for each non-conditional element of a conditional statement corresponding to each transition in the table A, a proposition that “the element is true while the conditional statement is true” and a preposition that “the element is false while the conditional statement is true”, and adds the created prepositions to the check proposition description 12. This state is shown in FIG. 15. In this way, the check proposition description 12 in which propositions enabling the variability of truth or false of each non-conditional element to be measured are described, is completed for all the conditional statements.

(2) The property check unit 13 performs a property check to the circuit description 11 by using the check proposition description 12.

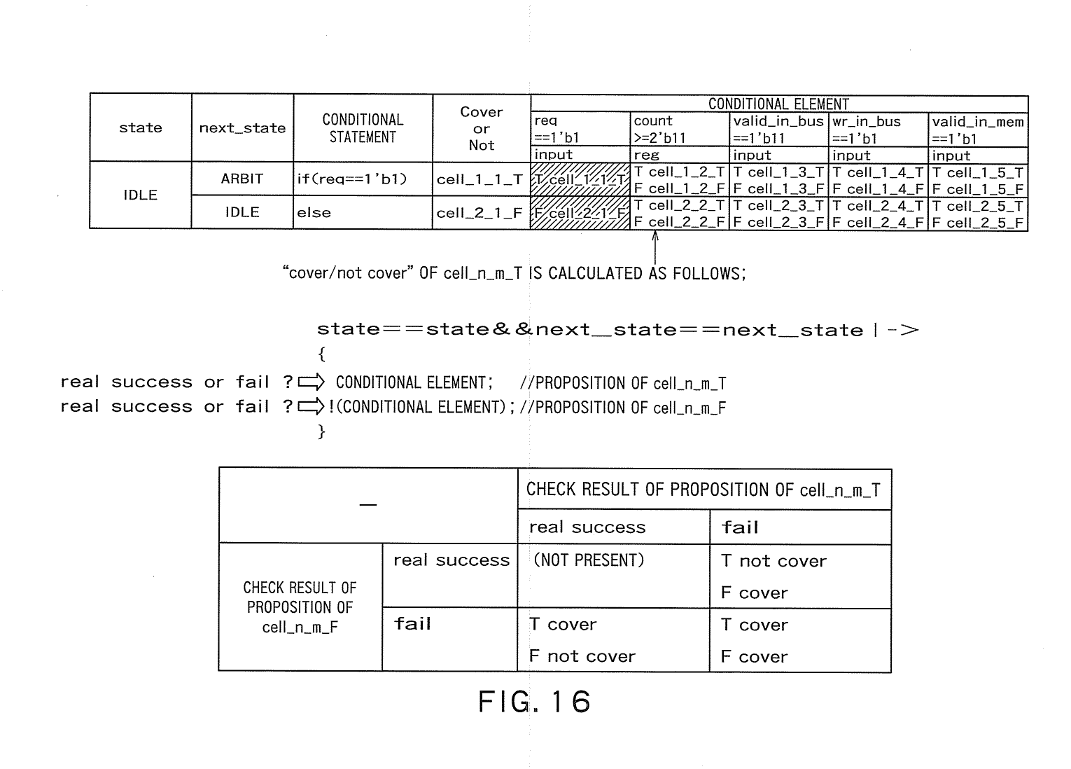

(3) The variability measurement/display unit 14 calculates, as shown in FIG. 16, “cover” and “not cover” by the combination of “real success” and “fail” of each proposition, and adds the calculation result to the table A. The term “real success” means that the proposition is satisfied, while the term “fail” means that the proposition is not satisfied. When the preposition that “the element is true while the conditional statement is true” is satisfied, cell_n_m_T becomes “real success” (=1). When the preposition that “the element is true while the conditional statement is true” is not satisfied, cell_n_m_T becomes “fail” (=0). When the preposition that “the element is false while the conditional statement is true” is satisfied, cell_n_m_F becomes “real success” (=1). When the preposition that “the element is false while the conditional statement is true” is not satisfied, cell_n_m_F becomes “fail” (=0). By the combination of the value of cell_n_m_T and cell_n_m_F, three kinds of coverage results (“cover” or “not cover”) are obtained for each cell (see the lowest table in FIG. 16). The coverage result is added to each cell in the table A, and thereby the same table B2 (not shown) as that in FIG. 13 is obtained (note that the contents of the table are of course different from those in the case of the simulation, in dependence upon the contents of the property description 9). The variability measurement/display unit 14 displays the obtained table B2.

As described above, according to the present embodiment, the calculation amount is increased by using the property check, and the verification time is increased, as compared with the case of simulation. However, it is possible to perform a comprehensive check, in addition to the limited test patterns as in the case of the simulation.

### Embodiment 3-2

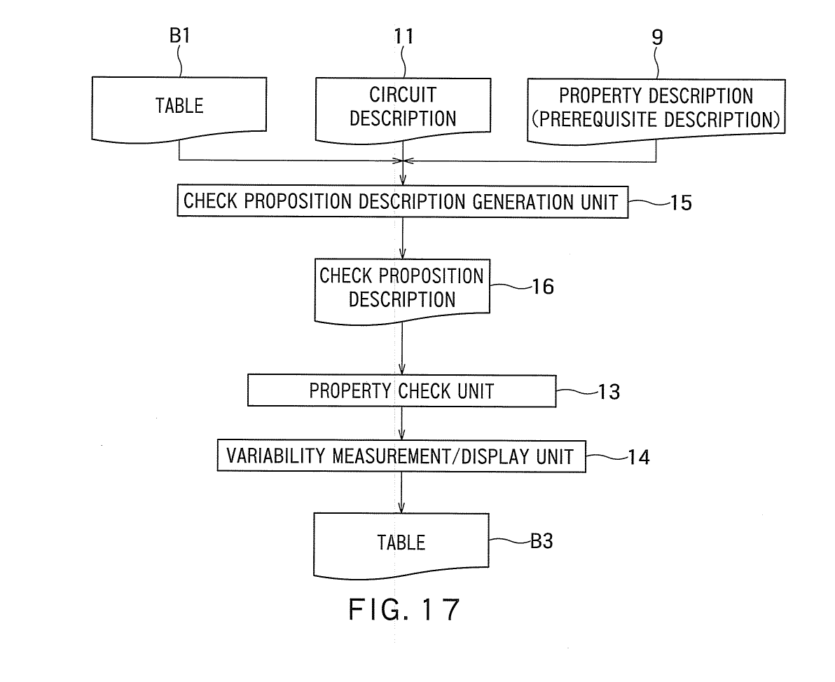

FIG. 17 shows a configuration of a system which executes a circuit design verification method, as Embodiment 3-2 according to the present invention. It is also possible to realize a function equivalent to the system by making a computer execute a program in which instruction codes for executing the circuit design verification method are described.

Into this system, there are inputted a circuit description 11 including a circuit description of a device under test (DUT) and a circuit description of the other circuit which operates cooperatively with the device under test (DUT), the table B1 (see FIG. 13) obtained by the simulation in Embodiment 2, and a property description (prerequisite description) 9 in which restrictions (for example, a restriction on a range of values that a signal can take, and a restriction on a relation between a signal value and the other signal value) relating to input signals and internal signals (req, count, valid_in_bus, and the like) of the device under test (DUT) are expressed by a property language.

A check proposition description generation unit 15 generates a check proposition description 16 for measuring truth or false of a non-conditional element of a conditional statement corresponding to each transition of the table A.

A property check unit (executing unit) 13 performs property check to the circuit description of the device under test (DUT) (to the state transition description similarly to Embodiment 3-1) by using the check proposition description 16.

A variability measurement/display unit (table generating unit, display unit) 14 obtains a table B3 by overwriting the result (coverage result) obtained by the property check on the table B1. The variability measurement/display unit 14 displays the table B3.

In the following, a system shown in FIG. 17 will be explained by using a specific example.

A designer/verifier or the system of Embodiment 2 inputs the circuit description 11, the table B1 (see FIG. 13) generated in Embodiment 2, and the property description (prerequisite description) 9.

The following processing is performed by the check proposition description generation unit 15, the property check unit 13, and the variability measurement/display unit 14.

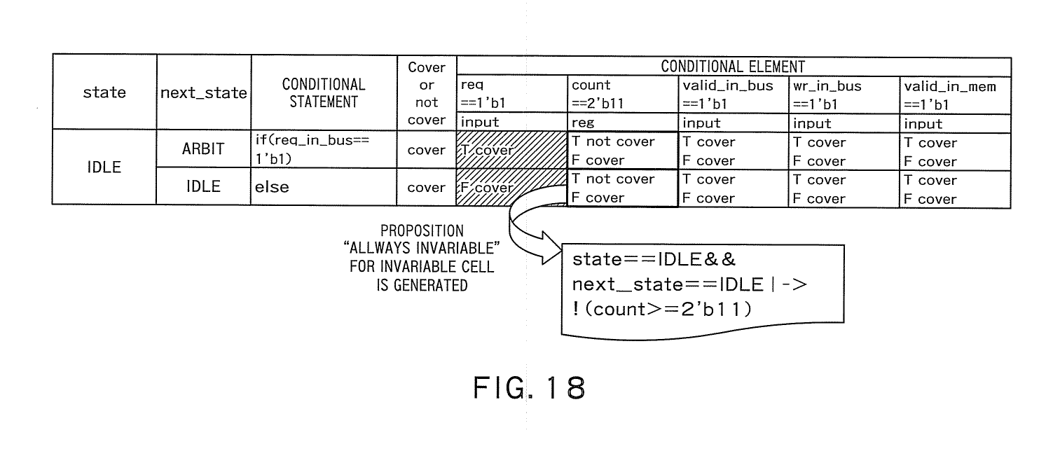

(1) The check proposition description generation unit 15 selects a cell whose variability is invariable in the table B1, and generates a proposition description that “the element is invariable (true or false) while the conditional statement is true”, for the conditional statement corresponding to the selected cell. This state is shown in FIG. 18.

(2) The property check unit 13 performs a property check to the circuit description 11 by using the check proposition description 16.

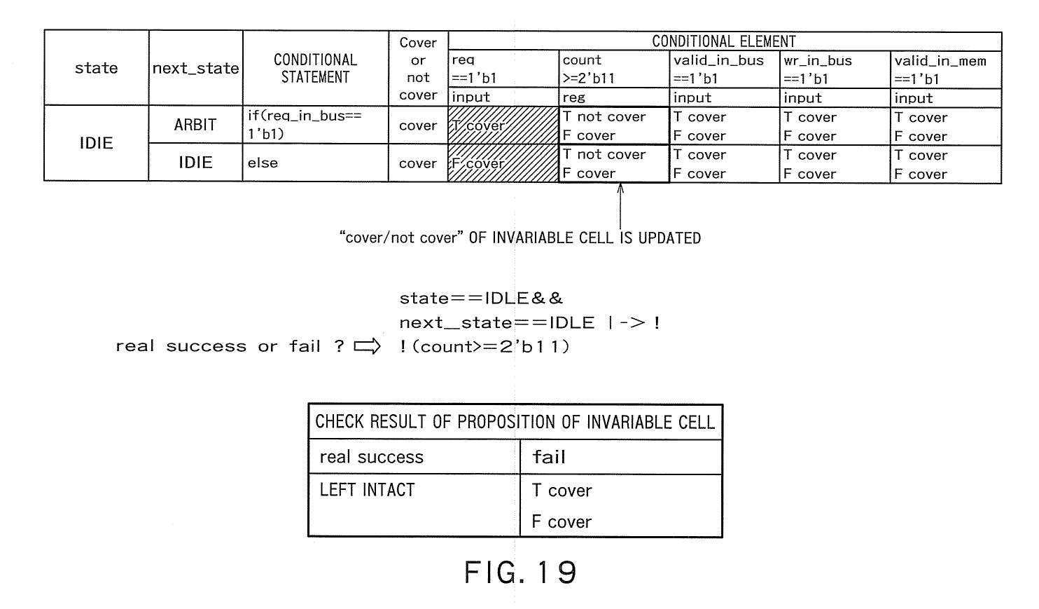

(3) The variability measurement/display unit 14 updates the contents (“cover” and “not cover”) of the cell of the table B1 according to “real success” and “fail” of each proposition, as shown in FIG. 19. When the checked result of the proposition is “real success” (true), the variability measurement/display unit 14 leaves the contents of the cell intact. When the checked result of the proposition is “fail” (false), the variability measurement/display unit 14 adds “cover” to both T and F, because there are both the case where the conditional element corresponding to the cell is true, and the case where the conditional element corresponding to the cell is false. The variability measurement/display unit 14 updates the variability coverage to all the cells whose variability is invariable, and thereby obtains the table B3. The variability measurement/display unit 14 displays the table B3.

As described above, according to the present embodiment, it is possible to reduce the calculation amount as compared with Embodiment 3-1, by using, after the simulation of Embodiment 2, the property check explained in Embodiment 3-2 only for the cell whose variability is invariable.

### Embodiment 4

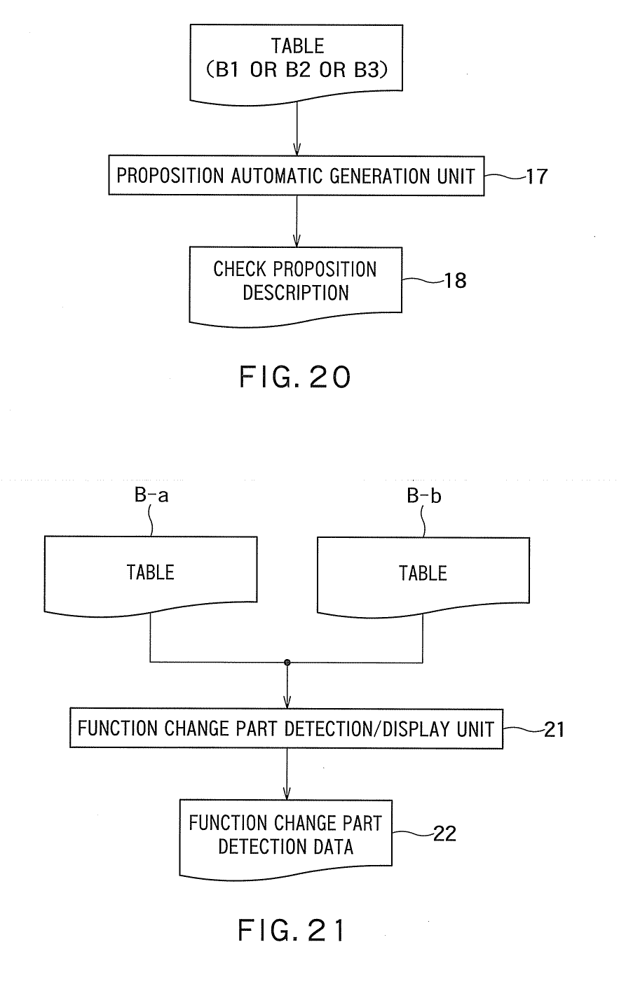

FIG. 20 shows a configuration of a system which executes a circuit design verification method, as Embodiment 4 according to the present invention. It is also possible to realize a function equivalent to the system by making a computer execute a program in which instruction codes for executing the circuit design verification method are described.

One of the tables (B1, B2 and B3) which are obtained in Embodiment 2, Embodiment 3-1, and Embodiment 3-2, is inputted into the system.

A proposition automatic generation unit 17 generates a check proposition description 18 for a cell whose variability is invariable in one of the tables (B1, B2 and B3), which is inputted into the system.

In the following, a system shown in FIG. 20 will be described by using a specific example.

The designer/verifier or one of the systems of Embodiment 2, Embodiment 3-1, and Embodiment 3-2 inputs one of the tables (B1, B2 and B3) which are generated in Embodiment 2, Embodiment 3-1, and Embodiment 3-2, into the present system.

The following processing is performed by the proposition automatic generation unit 17.

(1) The proposition automatic generation unit 17 selects a cell whose variability is invariable in one of the tables (B1, B2 and B3).

(2) The proposition automatic generation unit 17 generates for the selected cell a proposition description that “a conditional element is invariable (truth or false) while the condition is true”.

By the above processing, the proposition description as shown in FIG. 18 is automatically generated for the cell whose variability is invariable.

The check proposition description 18 generated by the proposition automatic generation unit 17 can be utilized by the functional checker (for example, the property check unit 13 in FIG. 17) of the device under test (DUT). Further, since the check proposition description 18 can also be used in the simulation as an assertion description which is a property description for the simulation, it is possible to use the check proposition description 18 under the environment in which a property check tool cannot be used. Thereby, the improvement in the verification accuracy can be realized.

### Embodiment 5

FIG. 21 shows a configuration of a system which executes a circuit design verification method, as Embodiment 5 according to the present invention. It is also possible to realize a function equivalent to the system by making a computer execute a program in which instruction codes for executing the circuit design verification method are described.

A table B-a which is obtained from one of Embodiment 2, Embodiment 3-1 and Embodiment 3-2 for a device under test in a designed system circuit, and a table B-b obtained from one of Embodiment 2, Embodiment 3-1 and Embodiment 3-2 for a device under test in a system circuit under new development are inputted into this system. It is assumed that the device under test of the system circuit under new development is the same as the device under test of the designed system circuit, and that all the circuits other than the device under test are different between the system circuit under new development and the designed system circuit. That is, it is assumed that the device under test of the system circuit under new development corresponds to a reused module.

A function change part detection/display unit (comparing unit, display unit) 21 compare the table B-a with table B-b, and detects a difference in the variability between the respective cells. The function change part detection/display unit 21 detects a part having the difference in the variability (a set of a conditional statement and a conditional element) as a function change part, and generates function change part detection data 22. The function change part detection/display unit 21 displays the function change part detection data 22.

In the following, the system shown in FIG. 21 will be explained by using a specific example.

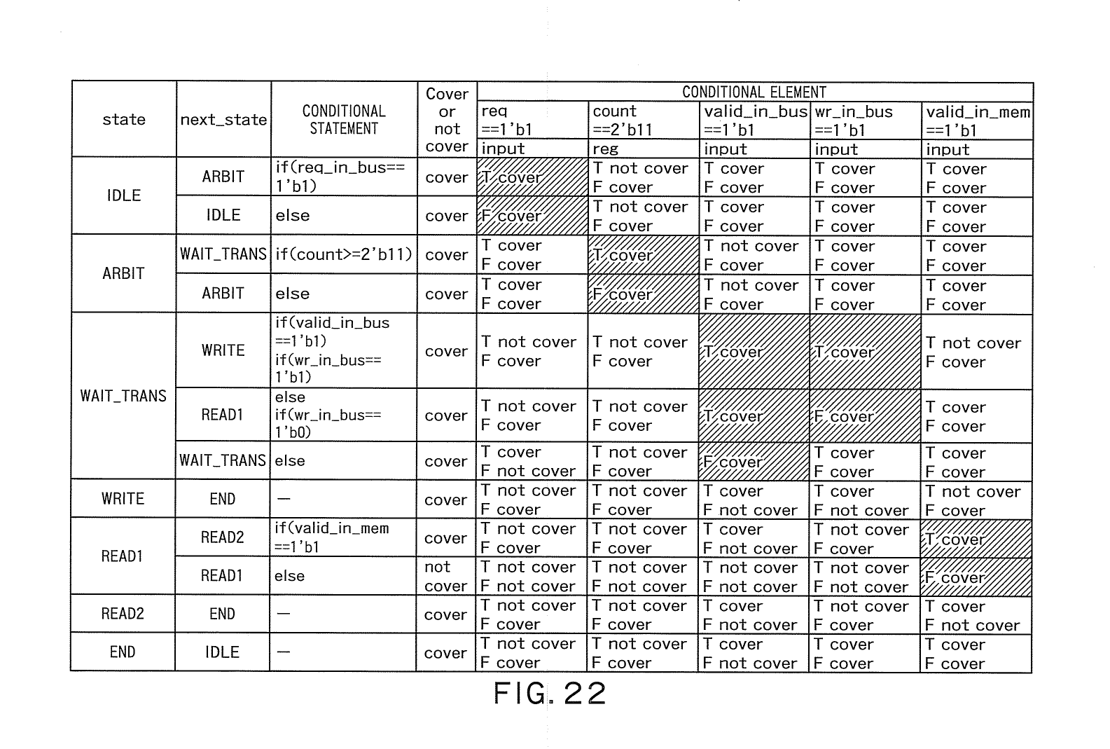

It is assumed that designer/verifier or one of the systems of Embodiment 2, Embodiment 3-1 and Embodiment 3-2 inputs the table in FIG. 13 as the table B-a, and inputs the table in FIG. 22 as the table B-b.

The following processing is performed by the function change part detection/display unit 21.

(1) The function change part detection/display unit 21 extracts coverage results (TA, FA) and (TB, FB) of cells corresponding to each other between the table B-a and table B-b.

(2) When (TA, FA) !=(TB, FB) (that is, when the coverage results are not coincident with each other), the function change part detection/display unit 21 performs detection and display of the non-coincident part as the function change part, as follows.

A) Non-coincidence=from “invariable” to “variable” (corresponding to first identification data)

When (TA, FA)=(cover, not cover) or (not cover, cover), and when (TB, FB)=(cover, cover), the function change part detection/display unit 21 detects a high possibility of insufficient function of the reused module, that is, a high possibility of description omission in the system circuit under new development.

B) Non-coincidence=from “variable” to “invariable” (corresponding to second identification data)

When (TA, FA)=(cover, cover), and when (TB, FB)=(cover, not cover) or (not cover, cover), the function change part detection/display unit 21 detects a high possibility that a certain function change has been performed in a module other than the reused module (for example, the master on the preceding stage of the reused module in FIG. 1).

C) Non-coincidence=from “invariable” to “invariable” (i.e. inversion) (corresponding to third identification data)

When (TA, FA)=(cover, not cover), (TB, FB)=(not cover, cover), or when (TA, FA)=(not cover, cover), (TB, FB)=(cover, not cover), the function change part detection/display unit 21 detects a high possibility that a certain function change has been performed in a module other than the reused module (for example, the master on the preceding stage of the reused module in FIG. 1).

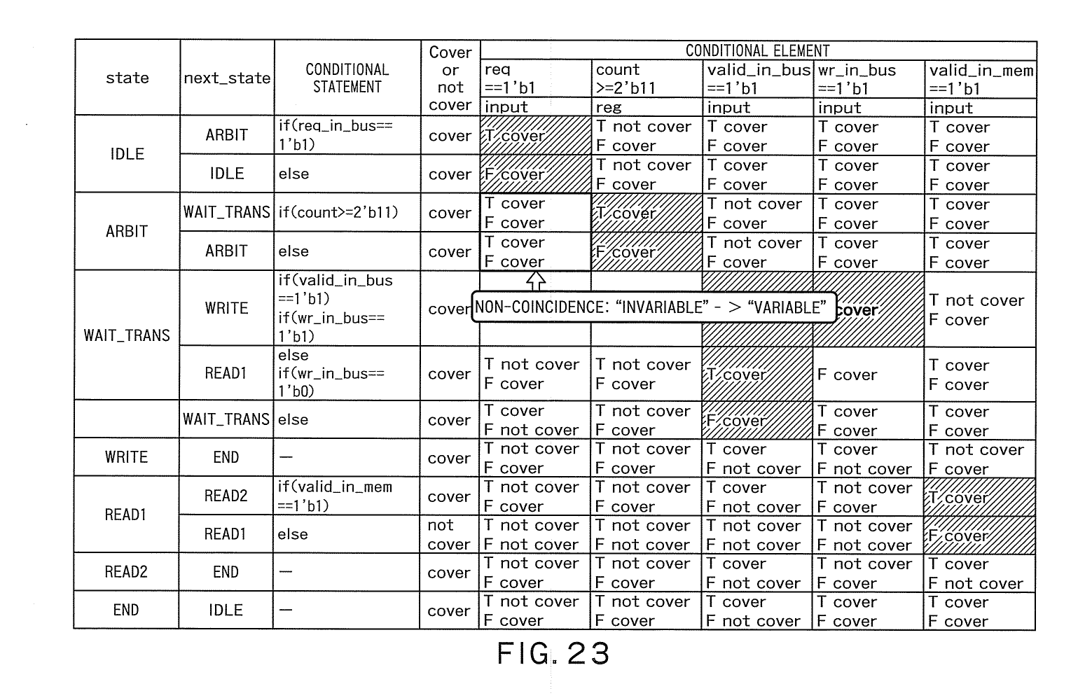

By the above processing, the function change parts (a set of a conditional statement and a conditional element which have a difference in the variability) are detected and displayed as shown in FIG. 23. This example shows that in the conditional statement “if (count >2′b11)” or its else term, “req==1′b1”, which is always true in the designed system circuit (see FIG. 13), may become false in the system circuit under new development. Thereby, it is possible to detect that the condition in which “req==1′b1” becomes false is missing or may be missing in the circuit description of the slave module reused in the system circuit under new development.

As described above, according to the present embodiment, a function change part which is difficult to be detected by the conventional coverage method can be acquired by the function change part detection/display unit 21. Thereby, it is possible to early find a functional bug, and to significantly reduce the debugging time. As a result, it is possible to realize the improvement in verification accuracy and the reduction of verification time.

What is claimed is:

1. A circuit design verification method comprising:
accepting input of a circuit description which describes a circuit by using a plurality of conditional statements each including one or more conditional elements;
extracting each conditional statement included in the circuit description and each conditional element included in the conditional statements;
executing the circuit description by using test data for the circuit; and
generating a table including verification information for each conditional statement, the verification information representing (A1) whether each conditional element has been always true, (A2) whether each conditional element has been always false, or (A3) whether each conditional element has been both true and false when the conditional statement is satisfied.

2. The method according to claim 1, further comprising comparing a first table generated from a first circuit description describing a first circuit, with a second table generated from a second circuit description describing a second circuit different from the first circuit.

3. The method according to claim 2, wherein the comparing detects a set of a conditional statement and a conditional element, in which the verification information is not coincident between the first table and the second table.

4. The method according to claim 3, further comprising displaying the verification information corresponding to a detected set in the first table and second table.

5. The method according to claim 4, wherein the displaying displays
first identification data when the first verification information indicates (A1) or (A2) and the second verification information indicates (A3),
second identification data when the first verification information indicates (A3) and the second verification information indicates (A1) or (A2), and
third identification data when the first verification information indicates (A1) or (A2) and the second verification information indicates (A1) or (A2).

6. The method according to claim 1, wherein the circuit description includes a description of a state transition machine which describes state transitions on the basis of true or false of the conditional statements,
wherein the generating a table specifies conditional statement sets to be satisfied to effect each state transition respectively and generates the table representing the verification information for each of the conditional statement sets.

7. The method according to claim 6, wherein the generating a table calculates a ratio of a number of the condition elements included in the condition statement set to a total number of the condition elements in the circuit description for each condition statement set and includes the ration calculated for each condition statement set in the table.

8. A circuit design verification apparatus comprising:
an input accepting unit configured to accept input of a circuit description which describes a circuit by using a plurality of conditional statements each including one or more conditional elements;
an extracting unit configured to extract each conditional statement included in the circuit description and each conditional element included in the conditional statements;
an executing unit configured to execute the circuit description by using test data for the circuit and;
a table generating unit configured to generate a table including verification information for each conditional statement, the verification information representing (A1) whether each conditional element has been always true, (A2) whether each conditional element has been always false, or (A3) whether each conditional element has been both true and false when the conditional statement is satisfied.

9. The apparatus according to claim 8, further comprising a comparing unit configured to compare a first table generated from a first circuit description describing a first circuit, with a second table generated from a second circuit description describing a second circuit different from the first circuit.

10. The apparatus according to claim 9, wherein the comparing unit detects a set of a conditional statement and a conditional element, in which the verification information is not coincident between the first table and the second table.

11. The apparatus according to claim 10, further comprising a displaying unit configured to display the verification information corresponding to a detected set in the first table and the second table.

12. The apparatus according to claim 11, wherein the displaying unit displays
first identification data when the first verification information indicates (A1) or (A2) and the second verification information indicates (A3),
second identification data when the first verification information indicates (A3) and the second verification information indicates (A1) or (A2), and
third identification data when the first verification information indicates (A1) or (A2) and the second verification information indicates (A1) or (A2).

13. The apparatus according to claim 8, wherein the circuit description includes a description of a state transition machine which describes state transitions on the basis of true or false of the conditional statements,
wherein the table generating unit specifies conditional statement sets to be satisfied to effect each state transition respectively and generates the table representing the verification information for each of the conditional statement sets.

14. The apparatus according to claim 13, wherein the table generating unit calculates a ratio of a number of the condition elements included in the condition statement set to a total number of the condition elements in the circuit description for each condition statement set and includes the ration calculated for each condition statement set in the table.

15. A computer readable medium storing a computer program for causing a computer to execute instructions to perform:
accepting input of a circuit description which describes a circuit by using a plurality of conditional statements each including one or more conditional elements;
extracting each conditional statement included in the circuit description and each conditional element included in the conditional statements;
executing the circuit description by using test data for the circuit; and
generating a table including verification information for each conditional statement, the verification information representing (A1) whether each conditional element has been always true, (A2) whether each conditional element has been always false, or (A3) whether each conditional element has been both true and false when the conditional statement is satisfied.

16. The medium according to claim 15, the program further including instructions to perform comparing a first table generated from a first circuit description describing a first circuit, with a second table generated from a second circuit description describing a second circuit different from the first circuit.

17. The medium according to claim 16, wherein the comparing detects a set of a conditional statement and a conditional element, in which the verification information is not coincident between the first table and the second table.

18. The medium according to claim 17, the program further including instructions to perform displaying the verification information corresponding to a detected set in the first table and second table.

19. The medium according to claim 18, wherein the displaying displays
first identification data when the first verification information indicates (A1) or (A2) and the second verification information indicates (A3),
second identification data when the first verification information indicates (A3) and the second verification information indicates (A1) or (A2), and
third identification data when the first verification information indicates (A1) or (A2) and the second verification information indicates (A1) or (A2).

20. The medium according to claim 15, wherein the circuit description includes a description of a state transition machine which describes state transitions on the basis of true or false of the conditional statements,
wherein the generating a table specifies conditional statement sets to be satisfied to effect each state transition respectively and generates the table representing the verification information for each of the conditional statement sets.
